(19) United States
(12) Patent Application Publication
(10) Pub. No.: US 2014/0166134 A1
(43) Pub. Date: Jun. 19, 2014

(54) Pump with Reduced Number of Moving Parts

(71) Applicant: INTERMOLECULAR, INC., San Jose, CA (US)

(72) Inventor: Peter Satitpunwaycha, Sunnyvale, CA (US)

(73) Assignee: INTERMOLECULAR, INC., San Jose, CA (US)

(21) Appl. No.: 13/715,957

(22) Filed: Dec. 14, 2012

(51) Int. Cl. G05D 7/01

(52) U.S. Cl. CPC G05D 7/0113
USPC 137/565.13; 137/565.3; 137/565.27; 137/565.33

(57) ABSTRACT

Embodiments provided herein describe pumps and methods for pumping fluids. A first fixed valve has a passageway extending therethrough with first and second ends. The first fixed valve is configured to allow fluid flow through the passageway towards the second end thereof and at least partially restrict fluid flow towards the first end thereof. A pumping structure is in fluid communication with the second end of the passageway of the first fixed valve. A second fixed valve has a passageway extending therethrough with third and fourth ends. The second fixed valve is configured to allow fluid flow through the passageway towards the fourth end thereof and at least partially restrict fluid flow towards the third end thereof. The third end of the passageway of the second fixed valve is in fluid communication with the pumping structure and the second end of the passageway of the first fixed valve.

The present invention relates to fluid pumps. More particularly, this invention relates to a fluid pump with a reduced number of moving parts.

### BACKGROUND OF THE INVENTION

Fluid pumps are utilized in a wide range of systems and devices. Depending on the system in which they are used, the pumps may be designed or manufactured so as to minimize particle contamination of the fluid being pumped, such as when “high purity” fluids are desired. However, such pumps typically include moving parts, such as diaphragms and/or check ball valves, to which the fluid is exposed.

Even when specialized materials are used, some particles are dislodged from the moving parts, thus causing at least some undesirable contamination of the fluid. Additionally, the use of diaphragms usually results in uneven pressures and flow rates, which in some applications, is undesirable.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is an isometric schematic view of a fluid pump system, according to some embodiments.

FIG. 2 is a cross-sectional view of a fixed valve within the fluid pump system of FIG. 1, according to some embodiments of the present invention.

FIG. 3 is an isometric view of a pumping structure within the fluid pump system of FIG. 1, according to some embodiments of the present invention.

FIG. 4 is an isometric schematic view of a fluid pump system, according to some embodiments of the present invention.

FIG. 5 is a graph describing operation of the fluid pump system of FIG. 5, according to some embodiments of the present invention.

FIGS. 6-10 are side views of a portion of the fluid pump system of FIG. 4 illustrating operation thereof, according to some embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Embodiments described herein provide pumps, pump systems, and methods for pumping fluids that may be used in a wide range of systems, including, for example, semiconductor and solar panel processing systems. Particle contamination may be minimized having a reduced number of moving parts, such as check valves or diaphragms, in contact with the fluid being pumped. This is accomplished by using two fixed valves, such as Tesla valves, in combination with a pumping structure.

In some embodiments, two fixed valves are connected in series between a fluid source and a fluid destination. A pumping structure is connected between the two fixed valves. The fixed valves serve as check valves such that when the pumping structure is pulling fluid, fluid from the fluid source passes through the first fixed valve into the pumping structure while the second fixed valve prevents any fluid from being drawn from the fluid destination into the pumping structure. When the pumping structure is pushing (or driving) the fluid, the fluid is forced from the pumping structure to the fluid destination through the second fixed valve while the first fixed valve prevents the fluid from returning to the fluid source. The fixed valves may be made of single, integral pieces of material, and thus not include any moving parts, so as to reduce the likelihood of any particle contamination to the fluid. The pumping structure may utilize a fluid-fluid interface (e.g., between air and a liquid) as a diaphragm and not include an physical diaphragm component, which further reduces the likelihood of particle contamination.

In some embodiments, the structure described above is repeated such that the pump includes multiple “arms” or “segments” (i.e., referred to as sections below). In such embodiments, the operation of the pumping structures may be coordinated to as to tune the flow of fluid as desired (e.g., to make the flow relatively constant or create a “pulsing flow”).

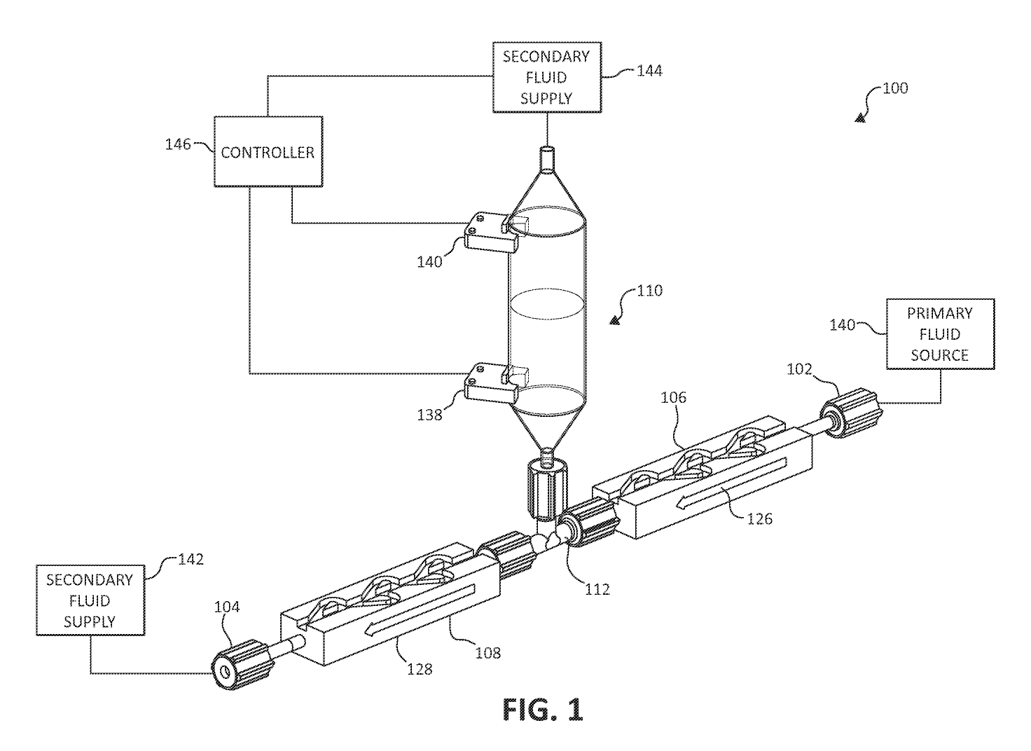

FIG. 1 illustrates a fluid pump (or fluid pump system) 100, according to some embodiments of the present invention. The fluid pump 100 includes an inlet 102, an outlet 104, a first fixed valve 106, a second fixed valve 108, and pumping structure 110. As shown, the first fixed valve 106 and the second fixed valve 108 are coupled (i.e., in fluid communication) in “series” such that fluid that first flows through the first fixed valve 106 then flows into the second fixed valve 108 through a fluid conduit assembly 112.

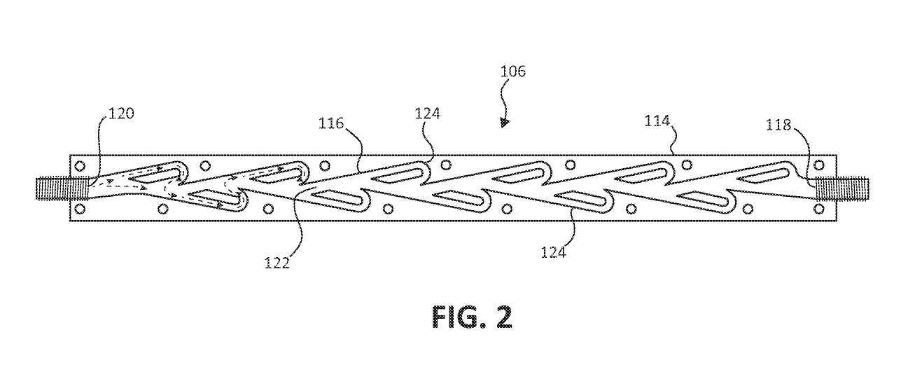

FIG. 2 illustrates the first fixed valve 106 in greater detail. Although only the first fixed valve is shown in detail, it should be understood that the second fixed valve 108 (FIG. 1) may be substantially identical to the first fixed valve. In some embodiments, the first fixed valve is a Tesla valve and thus be made from a single, integral piece of material (e.g., a plastic material or polytetrafluoroethylene (PTFE)). The first fixed valve 106 includes a body 114 with a (first) passageway 116 extending therethrough. The passageway 116 has a first end 118 at one end of the body 114 and a second end 120 at an opposing end of the body 114. However, it should be understood that the passageway extending through the second fixed valve 108 may also be referred to as a “second” passageway with “third” and “fourth” ends.

The passageway 116 also includes a main, central channel 122 and a series of arc-side channels 124, which branch off from, and reconnect to, the central channel 122 as shown in FIG. 2. As will be appreciated by one skilled in the art, the shape(s) of the arc-side channels 124 causes the first fixed valve 106 to function as a check valve, despite the lack of moving parts (e.g., a check ball). In particular, in the embodiments shown in FIG. 2, fluid (e.g., liquid) within the passageway 116 flows freely from the first end 118 of the passageway 116 towards the second end 120 of the passageway as fluid moving in that direction (i.e., a first direction) essentially bypasses the arc-side channels 124 and substantially only flows through the central channel 122.

However, if a force is applied to the fluid in the opposite direction (i.e., from the second end 120 of the passageway towards the first end 118 of the passageway 116, a second direction) some of the fluid will flow into the arc-side channels 124 and back into the central channel 122, which creates turbulence. This turbulence creates a force that resists the flow of the fluid in the second direction, towards the first end 118 of the passageway 116, which may prevent any fluid from flowing towards the first end 118 (i.e., depending on the applied pressure). Although the fixed valve 106 shown in FIG. 2 includes multiple arc-side channels 124, it should be understood that in other embodiments, fewer (e.g., as few as one) such channels may be included, as the number of the arc-side channels 124 may be changed to adjust the effectiveness of the “check valve” behavior of the fixed valves.

Referring again to FIG. 1, the first fixed valve 106 is arranged such that the first end 118 of the passageway 116 (FIG. 2) is adjacent to, and in fluid communication with, the inlet 102, while the second end 120 of the passageway 120 is adjacent to, and in fluid communication with, the fluid conduit assembly 112. As such, fluid may flow freely therethrough from the inlet 102 towards the fluid conduit assembly 112, as indicated by arrow/direction 126. The second fixed valve 108 is arranged such that the first end 118 of the passageway 116 therein is adjacent to, and in fluid communication with, the fluid conduit assembly 112, while the second end 120 of the passageway 116 therein is adjacent to, and in fluid communication with, the outlet 104. As such fluid may freely flow therethrough from the fluid conduit assembly 112 towards the outlet 104, as indicated by arrow/direction 128. The pumping structure 110 is coupled to the fluid conduit assembly 112 (i.e., between the first fixed valve 106 and the second fixed valve 108), and is thus in fluid communication with the first fixed valve 106 and the second fixed valve 108 (i.e., through the fluid conduit assembly 112).

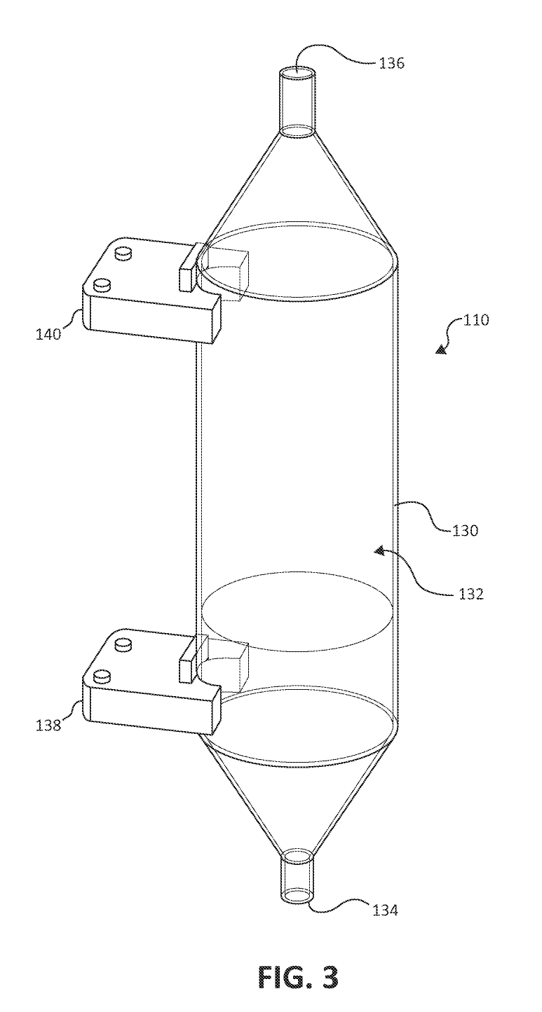

FIG. 3 illustrates the pumping structure 110, according to some embodiments, in greater detail. The pumping structure 110 includes a body 130 with a passageway (or reservoir) 132 extending therethrough, which fluidly connects a first opening 134 (e.g., at a lower end of the body 130) to a second opening 136 (e.g., at an upper end of the body 130). In the example shown, the body 130 is substantially cylindrical and is oriented such that a central axis (not shown) thereof is substantially perpendicular to directions 126 and 128 (FIG. 1). The body 130 may be made of a substantially transparent plastic material.

The pumping structure 130 also includes a fluid level indicator system (or at least one fluid level indicator). In some embodiments, the pumping structure 130 includes a lower fluid level sensor (or indicator) 138 and an upper fluid level sensor 140. The lower fluid level sensor 138 is connected to a side of the body 130 near the lower end thereof, and the upper fluid level sensor is connected to the side of the body 130 near the upper end thereof. In some embodiments, the level sensors 138 and 140 are optical sensors configured to detect the presence of a fluid (e.g., a liquid) and/or an interface between two fluids in adjacent portions of the passageway 132. Referring to FIG. 3 in combination with FIG. 1, the first opening 134 of the body 130 of the pumping structure 110 is in fluid communication with the fluid conduit assembly 112.

Referring again to FIG. 1, the fluid pump (system) 100 also includes a primary (or first) fluid source 140, a primary fluid destination 142, a secondary (or second) fluid supply 144, and a controller 146. The primary fluid source 140 includes a reservoir holding a fluid (i.e., primary fluid) to be pumped, such as a processing liquid, a fuel, etc., and is in fluid communication with the inlet 102. The primary fluid destination 142 is a portion of a system (e.g., a processing tool, an engine, etc.) to which the primary fluid is pumped/provided and is in fluid communication with the outlet 104.

Although not shown in detail, the secondary fluid supply 144 includes a reservoir holding a secondary, or “pumping,” fluid, such as a gas (e.g., air) or a liquid, and is in fluid communication with the second opening 136 of the body 130 of the pumping structure 110. Additionally, the secondary fluid supply 144 includes a (second) pump (not shown) for driving/drawing the secondary fluid into/out of the passageway 132 of the body 130 of the pumping structure 110.

The controller (or control sub-system) 146 includes a processor and memory, such as random access memory (RAM) and a hard disk drive. The controller 142 is in operable communication with the secondary fluid supply 144, the lower fluid level sensor 138, and the upper fluid level sensor 140. The controller 146 is configured to control the operation of the fluid pump 100 to perform the methods and processes described herein, based on, for example, signals generated by the fluid level sensors 138 and 140.

Still referring to FIG. 1, in operation, the fluid pump 100 may initially be primed by, for example, the secondary fluid supply 144 applying a vacuum to the pumping structure 110 (or the body 130, FIG. 3). The negative air pressure within the pumping structure 110 causes the primary fluid to be drawn through from the primary fluid source 140, through the first fixed valve 106 (i.e., in direction 126) and the fluid conduit assembly 112, and into the pumping structure 110 (i.e., the reservoir 132, FIG. 3).

When the level of the primary fluid (and/or an interface between the primary fluid and the secondary fluid) within the pumping structure 110 reaches the upper fluid level sensor 140, the secondary fluid supply 144 switches from applying a vacuum to the pumping structure 110 to forcing the secondary fluid (e.g., air) into the pumping structure 110. The secondary fluid being driven into the pumping structure 110 causes the primary fluid to be driven out of pumping structure 110 and into the fluid conduit assembly 112. Because of the configuration of the first fixed valve 106 described above, the primary fluid is prevented from flowing through the first fixed valve 106 towards the primary fluid source 140. However, the primary fluid, due to the configuration of the second fixed valve 108 described above, may freely flow though the second fixed valve (i.e., in direction 128) towards the outlet 104 and the primary fluid destination.

When the level of the primary fluid within the pumping structure 110 reaches (e.g., drops to) the lower fluid level sensor 138, the secondary fluid supply 144 again switches operation and begins drawing the secondary fluid from the pumping structure 110 (e.g., applying a vacuum to the pumping structure 110), thus drawing more primary fluid into the pumping structure 110 from the primary fluid source 140 through the first fixed valve 126, while the second fixed valve 108 prevents any primary fluid therein from flowing back into the pumping structure 110.

Thus, when the secondary fluid is drawn from the pumping structure 110 by the secondary fluid supply 144, the primary fluid is drawn into the pumping structure 110 through the first valve, and when the secondary fluid is driven into the pumping structure 110 by the secondary fluid supply 144, the primary fluid is driven out of the pumping structure 110 towards the primary fluid destination 142 through the second valve. This operation is repeated to continue the pumping action. It should be noted that because the primary fluid is only driven towards the primary fluid destination during approximately half of the pumping cycle, the primary fluid may flow through the outlet 104 in a series of “pulses.”

Still referring to FIG. 1, the first fixed valve 106, the second fixed valve 108, and the pumping structure 110 (as well as the secondary fluid supply 144) may jointly form a pump section, or portion, which in some embodiments is replicated so that the fluid pump includes several such sections, as is described in greater detail below.

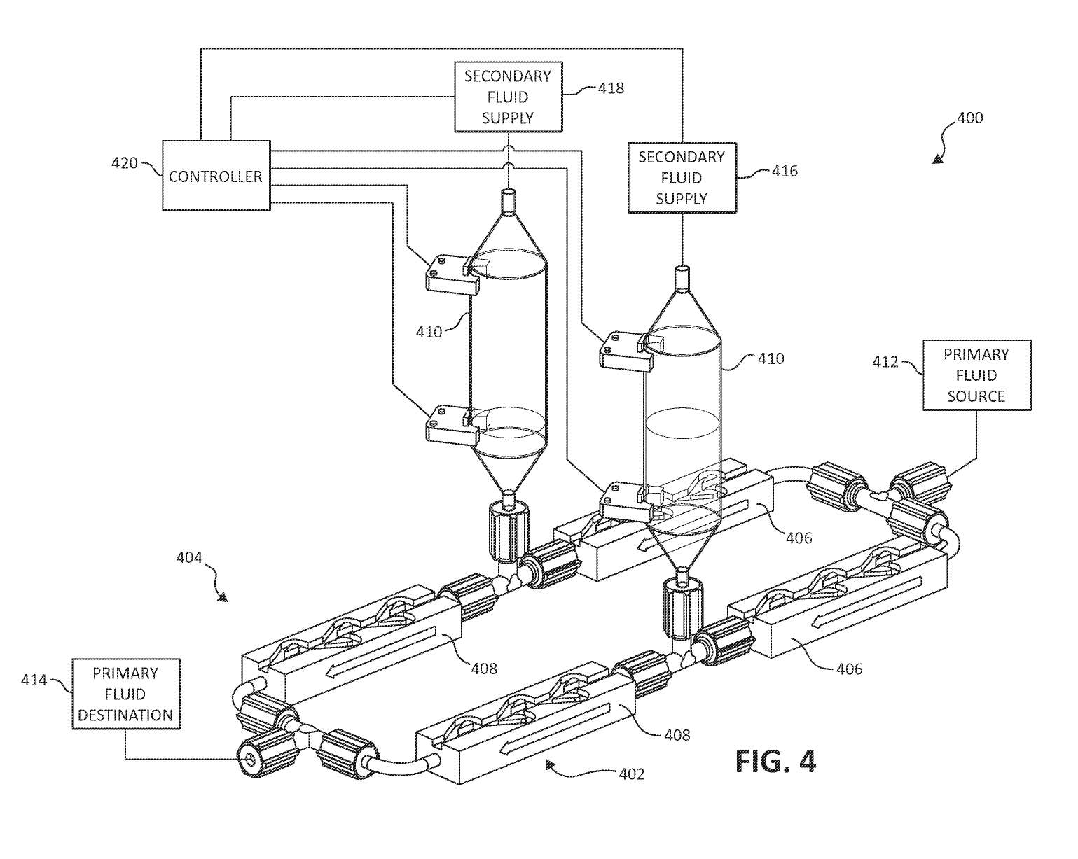

FIG. 4 illustrates a fluid pump (or fluid pump system) 400, according to other embodiments of the present invention. The fluid pump 400 includes first and second fluid pump sections 402 and 404, each of which includes first and second fixed valves 406 and 408 and a pumping structure 410, similar to the fluid pump 100 described above. Also included are a primary fluid source 412, a primary fluid destination 414, first and second secondary fluid supplies 416 and 418, and a controller 420.

As shown, the fluid pump sections 402 and 404 are connected in parallel between the primary fluid source 412 and the primary fluid destination 414. The first secondary fluid supply 416 is dedicated to the first fluid pump section 402 (i.e., in fluid communication with the pumping structure 410 of the first fluid pump section), while the second secondary fluid supply 418 is dedicated to the second fluid pump section 408.

According to one aspect of the present invention, the controller is configured to coordinate the operation of the first and second secondary fluid supplies 416 and 418 to tune the flow of the primary fluid to the primary fluid destination in a desired manner. For example, in some embodiments, the operation of the first and second secondary fluid supplies 416 and 418 is synchronized such that the flow of the primary fluid is pulsed.

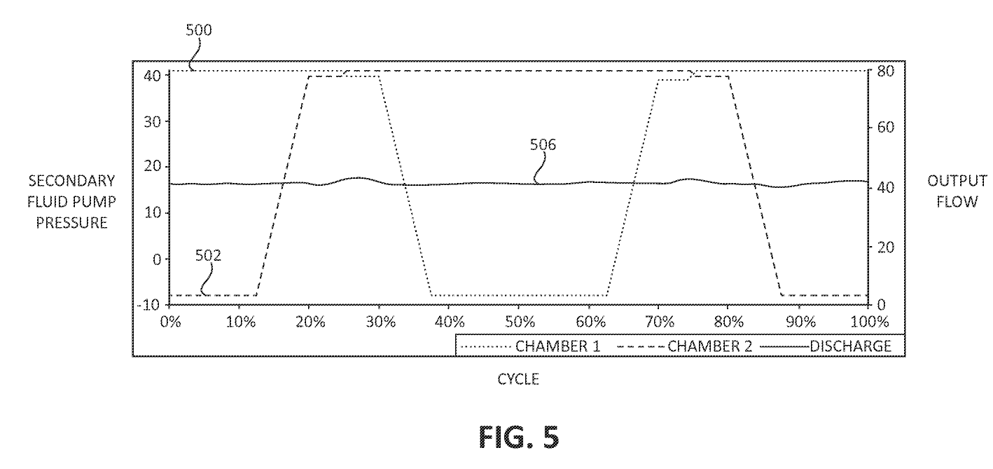

However, in other embodiments, the operation of the first and second secondary fluid supplies 416 and 418 is cross-phased. FIG. 5 graphically illustrates a cycle of the first and second fluid supplies 416 and 418 during an exemplary cross-phased operating scheme. Line 500 represents the pressure applied by the first secondary fluid supply 416 to the respective pumping structure, and line 502 represents the pressure applied by the second secondary fluid supply 418 to the respective pumping structure.

As shown in FIG. 5, in embodiments using air (or other gas) as the secondary fluid, within the cycle, the first secondary fluid supply 500 initially applies positive pressure, while the second secondary fluid supply 502 applies a negative pressure (e.g., a vacuum). Approximately 15% through the cycle, the second secondary fluid supply 502 increases pressure to approximately that off the first secondary fluid supply 500 (i.e., so both supplies are applying positive pressure). Then, at approximately 30% through the cycle, the first secondary fluid supply 500 decreased the applied pressure (e.g., a vacuum). At approximately 65% of the cycle, the first secondary fluid supply 500 increases pressure, and then at approximately 80% of the cycle, the second secondary fluid supply 502 decreases. The result of such operation is that the output flow of the pump 400 (FIG. 4) is approximately constant, as opposed to “pulsed,” as indicated by line 506.

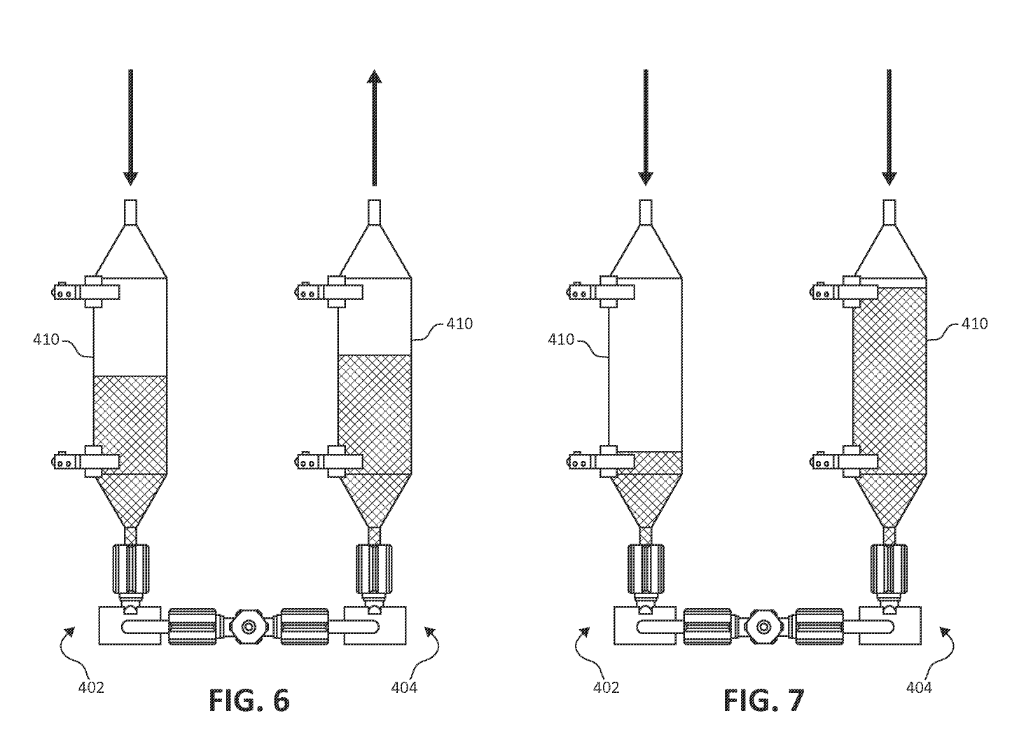

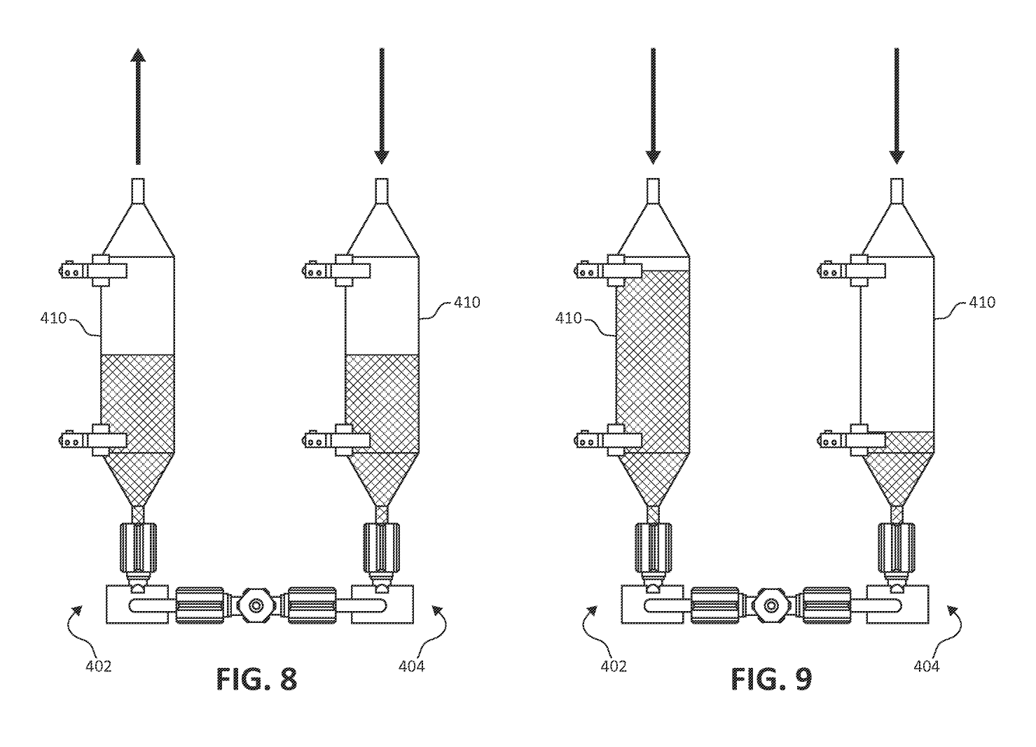

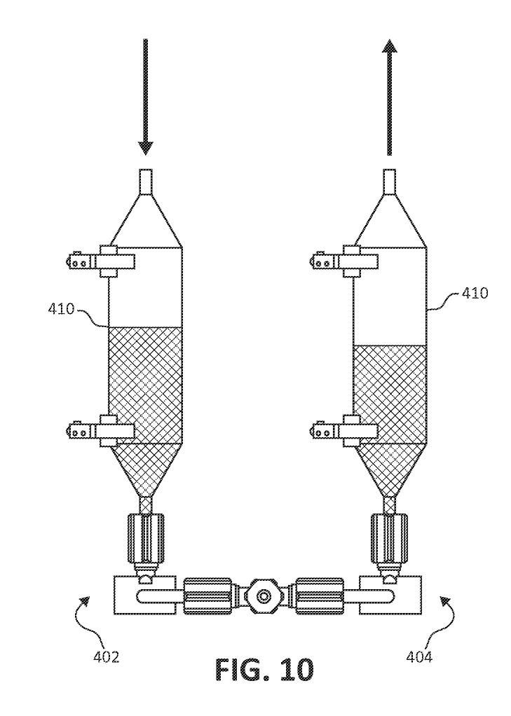

FIGS. 6-10 illustrate the flow of the primary fluid (and the secondary fluid) into and out of the pumping structures 410 of the first and second pump sections 402 and 404 when the fluid pump 400 (FIG. 4) is operated in a manner similar to that depicted in FIG. 5. In FIG. 6, the primary fluid is being driven out of the pumping structure 410 of the first pump section 402, while the primary fluid is being drawn into the pumping structure 410 of the second pump section. In FIG. 7, the primary fluid is being driven out of the pumping structures 410 of the first and second pumps sections 402 and 404 simultaneously. In FIG. 8, the primary fluid is being drawn into the pumping structure 410 of the first pump section 402, while the primary fluid is being driven out of the pumping structure 410 of the second pump section. In FIG. 9, the primary fluid is being drawn into the pumping structures 410 of the first and second pumps sections 402 and 404 simultaneously. In FIG. 10, the primary fluid is being driven out of the pumping structure 410 of the first pump section 402, while the primary fluid is being drawn into the pumping structure 410 of the second pump section, in a manner similar to that shown in FIG. 6.

Using such a cross-phased operation, the output flow of the fluid pump 400 (FIG. 4) may be made more constant, as opposed to pulsing output. Additionally, it should be understood that other embodiments may utilize more than two pump sections, and the operation of which may be further tuned to, for example, provide an even more constant output flow. For example, fluid pulsing may further be minimized by modulating the amplitude and frequency of the pressure and vacuum of the secondary fluid supplies in addition to cross-phased the pumping action.

Thus, in some embodiments, a pump is provided. The pump includes a first fixed valve, a pumping structure, and a second fixed valve. The first fixed valve has a first passageway extending therethrough with a first end and a second end. The first fixed valve is configured to allow the flow of fluid through the first passageway from the first end to the second end thereof and at least partially restrict the flow of fluid from the second end to the first end thereof. The pumping structure is fluid communication with the second end of the first passageway of the first fixed valve. The second fixed valve has a second passageway extending therethrough with a third end and a fourth end. The second fixed valve is configured to allow the flow of fluid through the second passageway from the third end to the fourth end thereof and at least partially restrict the flow of fluid from the fourth end to the third end thereof. The third end of the second passageway of the second fixed valve is in fluid communication with the pumping structure and the second end of the first passageway of the first fixed valve.

In other embodiments, a pump is provided. The pump includes a first fixed valve, a pumping structure, a second fixed valve, a second fluid source, and a controller. The first fixed valve has a first passageway extending therethrough with a first end and a second end. The first fixed valve is configured to allow the flow of a first fluid from a first fluid source through the first passageway from the first end to the second end thereof and at least partially restrict the flow of the first fluid from the second end to the first end thereof. The pumping structure in fluid communication with the second end of the first passageway of the first fixed valve. The pumping structure includes a body and at least one fluid level indicator coupled to the body. The second fixed valve has a second passageway extending therethrough with a third end and a fourth end. The second fixed valve is configured to allow the flow of the first fluid through the second passageway from the third end to the fourth end thereof and at least partially restrict the flow of the first fluid from the fourth end to the third end thereof. The third end of the second passageway of the second fixed valve is in fluid communication with the pumping structure and the second end of the first passageway of the first fixed valve. The second fluid source is in fluid communication with the body of the pumping structure. The second fluid source is configured to drive a second fluid into the body of the pumping structure and draw the second fluid from the body of the pumping structure. The controller is in operable communication with the second fluid source and the at least one level indicator. The controller is configured to control the second fluid source based on a signal generated by the at least one fluid level indicator.

In further embodiments, a method for pumping a fluid is provided. Fluid is drawn through a first fixed valve with a pumping structure. The first fixed valve is configured to allow the flow of fluid therethrough towards the pumping structure and at least partially restrict the flow of fluid therethrough away from the pumping structure. The pumping structure and first fixed valve are in fluid communication with a second fixed valve. The second fixed valve is configured to allow the flow of fluid therethrough away from the pumping structure and at least partially restrict the flow of fluid therethrough towards the pumping structure such that a majority of the fluid drawn through the first fixed valve flows into the pumping structure. The fluid is driven out of the pumping structure. The configuration of the first fixed valve and the second fixed valve causes a majority of the fluid driven out of the pumping to flow away from the pumping structure through the second fixed valve.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A pump comprising:
a first fixed valve having a first passageway extending therethrough with a first end and a second end, the first fixed valve being configured to allow a flow of fluid through the passageway from the first end to the second end thereof and at least partially restrict a flow of fluid from the second end to the first end thereof;
a pumping structure in fluid communication with the second end of the first passageway of the first fixed valve; and
a second fixed valve having a second passageway extending therethrough with a third end and a fourth end, the second fixed valve being configured to allow a flow of fluid through the second passageway from the third end to the fourth end thereof and at least partially restrict a flow of fluid from the fourth end to the third end thereof, the third end of the second passageway of the second fixed valve being in fluid communication with the pumping structure and the second end of the passageway of the first fixed valve.

2. The pump of claim 1, wherein the pumping structure comprises a body, and wherein when fluid is drawn into the body, fluid flows from the first end of the first passageway of the first fixed valve to the second end of the first passageway of the first fixed valve and into the body and fluid is at least partially restricted from flowing from the fourth end of the second passageway of the second fixed valve to the third end of the second passageway of the second fixed valve.

3. The pump of claim 2, wherein when fluid is driven out of the body of the pumping structure, fluid flows from the third end of the second passageway of the second fixed valve to the fourth end of the second passageway of the second fixed valve and into the body and fluid is at least partially restricted from flowing from the second end of the first passageway of the first fixed valve to the first end of the first passageway of the first fixed valve.

4. The pump of claim 3, wherein the first fixed valve and the second fixed valve are made from a single, integral piece of material.

5. The pump of claim 4, wherein the first fixed valve and the second fixed valves are Tesla valves.

6. The pump of claim 1, wherein the body of the pumping structure comprises a pumping structure passageway extending therethrough with first end and a second end, the first end of the pumping structure passageway being in fluid communication with the second end of the first passageway of the first fixed valve and the third end of the second passageway of the second fixed valve.

7. The pump of claim 6, further comprising a pumping fluid source in fluid communication with second end of the pumping structure passageway, the pumping fluid source being configured to drive a pumping fluid into the second end of the pumping structure passageway and draw the pumping fluid from the second end of the pumping structure passageway, said driving of the pumping fluid into the second end of the pumping structure passageway causing fluid to be driven from the first end of the pumping structure passageway and said drawing of the pumping fluid from the second end of the pumping structure causing fluid to be drawn into the first end of the pumping structure passageway.

8. The pump of claim 7, further comprising at least one fluid level indicator coupled to the body of the pumping structure, the at least one fluid level indicator being configured to generate a signal representative of a level of the fluid within the body of the pumping structure.

9. The pump of claim 8, further comprising a controller in operable communication with the pumping fluid source and the at least one fluid level, the controller being configured to control said driving and drawing of the pumping fluid based on the signal generated by the at least one fluid level indicator.

10. The pump of claim 1, wherein the first fixed valve, the pumping structure, and the second fixed valve jointly form a first pump section, and wherein the pump further comprises a second pump section coupled to the first pump section such that fluid flowing through the second pump section flows in parallel with fluid flowing through the first pump section.

11. A pump comprising:
a first fixed valve having a first passageway extending therethrough with a first end and a second end, the first fixed valve being configured to allow a flow of a first fluid from a first fluid source through the first passageway from the first end to the second end thereof and at least partially restrict a flow of the first fluid from the second end to the first end thereof;
a pumping structure in fluid communication with the second end of the first passageway of the first fixed valve, the pumping structure comprising a body and at least one fluid level indicator coupled to the body;
a second fixed valve having a second passageway extending therethrough with a third end and a fourth end, the second fixed valve being configured to allow a flow of the first fluid through the second passageway from the third end to the fourth end thereof and at least partially restrict a flow of the first fluid from the fourth end to the third end thereof, the third end of the second passageway of the second fixed valve being in fluid communication with the pumping structure and the second end of the first passageway of the first fixed valve;
a second fluid source in fluid communication with the body of the pumping structure, the second fluid source being configured to drive a second fluid into the body of the pumping structure and draw the second fluid from the body of the pumping structure; and
a controller in operable communication with the second fluid source and the at least one level indicator, the controller being configured to control the second fluid source based on a signal generated by the at least one fluid level indicator.

12. The pump of claim 11, wherein said driving of the second fluid into the body of the pumping structure causes the first fluid to be driven from the body of the pumping structure, and said drawing of the second fluid from the body of the pumping structure causes the first fluid to be drawn into the body of the pumping structure.

13. The pump of claim 12, wherein the at least one fluid level indicator is configured to generate a signal representative of a level of the first fluid in the body of the pumping structure.

14. The pump of claim 11, wherein the first fixed valve and the second fixed valve are Tesla valves.

15. The pump of claim 13, wherein the first fixed valve, the pumping structure, the second fixed valve, and the second fluid source jointly form a first portion of the pump, and wherein the pump further comprises a second portion coupled to the first pump portion such that fluid flowing through the second pump portion flows in parallel with fluid flowing through the first pump portion, and wherein the controller is configured to control the respective second fluid sources of the first and second pump portions such that during a first portion of a cycle of operation of the pump, the first fluid is driven from the bodies of the respective pumping structures of the first pump portion and the second pump portion, and during a second portion of the cycle of operation of the pump, the first fluid is driven from the body of the pumping structure of the first pump portion or the body of the pumping structure of the second pump portion.

16. A method for pumping a fluid, the method comprising:
drawing fluid through a first fixed valve with a pumping structure, first fixed valve being configured to allow a flow of fluid therethrough towards the pumping structure and at least partially restrict a flow of fluid therethrough away from the pumping structure, wherein the pumping structure and first fixed valve are in fluid communication with a second fixed valve and the second fixed valve is configured to allow a flow of fluid therethrough away from the pumping structure and at least partially restrict a flow of fluid therethrough towards the pumping structure such that a majority of the fluid drawn through the first fixed valve flows into the pumping structure; and
driving the fluid out of the pumping structure, wherein said configuration of the first fixed valve and the second fixed valve causes a majority of the fluid driven out of the pumping to flow away from the pumping structure through the second fixed valve.

17. The method of claim 16, wherein the first fixed valve and the second fixed valve are made from a single, integral piece of material.

18. The method of claim 17, wherein the first fixed valve and the second fixed valves are Tesla valves.

19. The method of claim 16, wherein the drawing of the fluid into the pumping structure comprises drawing a second fluid from the pumping structure, and the driving of the fluid out of the pumping structure comprises driving the second fluid into the pumping structure.

20. The method of claim 16, further comprising detecting a fluid level of the fluid within the pumping structure and generating a signal representative thereof.
